(19) United States
(12) Patent Application Publication
(10) Pub. No.: US 2023/0002624 A1
(43) Pub. Date: Jan. 5, 2023

(54) ELECTRODEPOSITION COATING MATERIAL CONTAINING CATECHOL DERIVATIVES AS ANTICORROSION AGENTS

(71) Applicant: BASF COATINGS GMBH, Munster (DE)

(72) Inventors: Thorsten Gelbrich, Munster (DE); Andrea Hoene, Munster (DE); Nina Wissmann, Munster (DE); Susanne Hemker, Munster (DE); Petra Toboll, Munster (DE); Justina Muehlmeyer, Munster (DE); Andre Brosseit, Munster (DE)

(21) Appl. No.: 17/778,483

(22) PCT Filed: Nov. 19, 2020
(86) PCT No.: PCT/EP2020/082692

§ 371 Date: May 20, 2022

(30) Foreign Application Priority Data
Nov. 22, 2019 (EP) 19210956.9

(51) Int. Cl. C09D 5/44; C25D 13/08

(52) U.S. Cl. CPC C09D 5/4492; C25D 13/08; C09D 5/4496; C09D 5/4411; C09D 5/4434

(57) ABSTRACT

Described herein is an electrodepositable coating material including one or more cathodically electrodepositable resins (A); one or more crosslinking agents (B); and one or more compounds represented by formula (I)

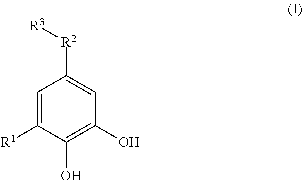

where R¹═H or OH; R²=a divalent radical selected from the group consisting of *C(O)—O, (HO)*CH—CH₂ and *CH₂—CH₂, with * denoting the carbon atom which is bound to the benzene ring; and R³=a monovalent radical. Also described herein is a method of coating a metallic substrate including the steps of dipping a metallic substrate into an electrodeposition bath containing the electrodepositable coating material; switching the substrate as a cathode; depositing the electrodepositable coating material onto the substrate to form a coating layer; and drying and curing the thus formed coating layer. Further described herein is a method of using the compounds of formula (I) as anticorrosion agents in electrodeposition paints and coated substrates.

The present invention relates to electrodeposition coating materials containing catechol derivatives as anticorrosion agents, a method of coating substrates with the electrodeposition coating material, the use of catechol derivatives as anticorrosion agents in electrodeposition paints and coatings obtained from the electrodeposition coating materials.

### BACKGROUND OF THE INVENTION

A normal requirement within the automobile sector is that the metallic components used for manufacture must be protected against corrosion. The requirements concerning the corrosion prevention to be achieved are very stringent, especially as the manufacturers often give a guarantee against rust perforation over many years. Such corrosion prevention is normally achieved by coating the components, or the substrates used in their manufacture, with at least one coating apt for the purpose.

A disadvantage of the known coating methods, particularly affecting the known methods employed within the automobile industry, is that these methods normally envisage a phosphatizing pretreatment step, in which the substrate for coating, after an optional cleaning step and before a deposition coating step, is treated with a metal phosphate such as zinc phosphate in a phosphatizing step, to ensure adequate corrosion prevention. This pretreatment normally entails the implementation of a plurality of method steps in a plurality of different dipping tanks with different heating. During the implementation of such pretreatment, moreover, waste sludges are produced, which burden the environment and must be disposed of. On environmental and economic grounds, therefore, it is especially desirable to be able to forgo such a pretreatment step, but nevertheless to achieve at least the same corrosion prevention effect as achieved using the known methods. Modern thin film pretreatment technologies based on conversion layers based on zirconium show clear advantages concerning number of process steps, energy consumption and sludge formation and represent an alternative to the phosphatization, but the protection performance is in most cases not equivalent due to a missing active corrosion protection that actively protects the substrate by leachable and mobile components (like phosphate) which form a protection layer in the defect.

Furthermore, in many cases there is an insufficient corrosion protection on multi-metal substrates, such substrates comprising surface areas of different metal composition. In many cases, particularly in automotive coatings, substrates composed of different metals are preassembled to workpieces, particularly automotive parts such as auto bodies, which are subsequently coated in an electrodeposition coating method.

In other cases, it is intended to coat substrates composed of only one metal or one type of alloy in the same electrodeposition bath.

Particularly important is the ability of electrodeposition coating materials (i.e. electrodeposition paints) to employ the therewith coated substrates with anticorrosive properties on a large variety of metallic substrates, particularly aluminum substrates.

Corrosion of aluminum differs from the corrosion of iron containing substrates significantly. Particularly filiform corrosion is often observed on aluminum-based substrates such as pure aluminum or aluminum alloys.

Therefore, a need exists for electrodepositable coating compositions for coating of electrically conductive substrates with an electrodeposition coating material that permits—especially with a view to forgoing the normally implemented phosphatizing pretreatment step—a more economic and more environmental coating method than conventional coating compositions used, while being nevertheless suitable at least in equal degree for achieving the corrosion prevention effect necessary for such compositions.

Therefore, it is an object of the present invention, to provide a coating composition for coating of an electrically conductive substrate that has advantages over the coating compositions known from the prior art. It is an object of the present invention to provide coating compositions which permit a more economic and/or environmentally friendly coating method than conventional coating compositions used. Moreover, it is an object of the present invention, to provide a method which allows more economic and/or environmentally friendly coating than conventional coating methods, which, in other words, makes it possible, for example, to forgo the phosphatizing which must normally be carried out by means of a metal phosphate even prior to deposition coating, but with which, nevertheless, at least the same, and more particularly an enhanced, corrosion prevention effect can be achieved compared to the normal methods.

Particularly, aluminum-based substrates should be protected from corrosion, while the coating materials should also preferably be suitable to employ corrosion resistance to other metallic substrates such as different kinds of steel.

While the known art often makes use of anticorrosive pigments or specific organometallic or metal containing catalyst to enhance crosslinking efficiency in such electrodeposition paints, it was the aim of the present invention to achieve excellent anticorrosive properties with electrodepositable coating materials by adding specific water soluble organic compounds, even compounds occurring in nature or simple derivatives of such compounds and therefore being environmentally non-problematic.

While a treatment composition for steel is know from EP 0 298 150 A1, thus not being an electrodepositable coating composition, said composition contains a quercetin derivative of monogalloylellagic acid. However, such composition does not contain crosslinkable binders and crosslinkers and contains significant amounts of phosphoric acid and zinc phosphate both known to act as anticorrosive compounds, but also known as unwanted impurities in electrodeposition paints.

From DE 196 23 274 A1 and EP 3 156 522 A1 tin electroplating bathes are known which contain different organic, particularly flavonoid compounds and glycosides thereof. However, other than in electrodeposition of a coating material, electroplating leads to the formation of a tin plating film and no organic binders are deposited and crosslinked afterwards.

U.S. Pat. No. 6,235,348 B1 discloses rust preventive compositions, particularly a method for preventing Zn-based metallic coating formed on a base from rusting. On a first coating film comprising a silicic acid compound and an aromatic amine-based condensation product, a second coating film containing a phosphoric acid compound, an organic compound an organic polymer is formed, where the organic compound can be a polyhydroxyfunctional natural organic compound. However, this second coating composition does not contain a cathodically electrodepositable crosslinkable resin and a crosslinker.

Further, it is particularly preferred that electrodepositable coating compositions should not contain phosphoric acid or its salts.

It was the aim of the present invention to overcome the afore-mentioned drawbacks and to provide an electrodepositable coating material which is apt to provide corrosion protection to different metal substrates and preferably multi-metal substrates, particularly to aluminum comprising substrates even without pre-treatment such as conversion coating like phosphatizing.

### SUMMARY

The problems to be solved by the present invention were solved by providing an electrodepositable coating material comprising
i. one or more cathodically electrodepositable resins (A);
ii. one or more crosslinking agents (B); and
iii. one or more catechol derivatives (C) represented by formula (I)

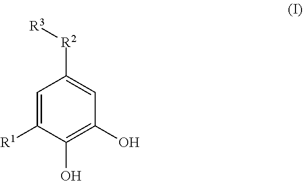

wherein
R¹ is H or OH;
R² is a divalent radical selected from the group consisting of *C(O)—O, (HO)*CH—CH₂ or *CH₂—CH₂, with * denoting the carbon atom which is bound to the benzene ring; and
R³ is a monovalent radical selected from the group consisting of NH₂, (H₃N⁺)X⁻, NHR⁴, (⁺NH₂R⁴)X⁻, or R⁴, wherein X is the anion of an organic or inorganic acid and R⁴ a linear or branched alkyl group having 1 to 6 carbon atoms.

A further object of the present invention is a method of coating a metallic substrate comprising the steps of
a. dipping a metallic substrate into an electrodeposition bath containing the electrodepositable coating material of the present invention;
b. switching the substrate as a cathode;
c. depositing the electrodepositable coating material onto the substrate to form a coating layer;
d. spray or dip cleaning of the coated substrate; and
e. drying and curing the thus formed coating layer.

Yet another object of the present invention is the use of one or more catechol derivatives (C) represented by formula (I)

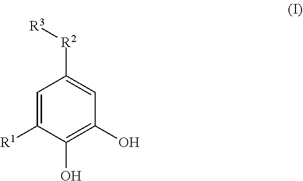

wherein
R¹ is H or OH;
R² is a divalent radical selected from the group consisting of *C(O)—O, (HO)*CH—CH₂ or *CH₂—CH₂, with * denoting the carbon atom which is bound to the benzene ring; and
R³ is a monovalent radical selected from the group consisting of NH₂, (H₃N⁺)X⁻, NHR⁴, (⁺NH₂R⁴)X⁻, or R⁴, wherein X is the anion of an organic or inorganic acid and R⁴ a linear or branched alkyl group having 1 to 6 carbon atoms,

as anticorrosion agents in electrodeposition coating materials.

A further object of the present invention is a coating and a coated substrate obtained according to the method of the present invention.

Further objects of the present invention are multilayer coated metallic substrates, wherein the first coating layer on the metallic substrate is formed according to the method of the present invention.

### DETAILED DESCRIPTION

Electrodepositable Coating Composition

The electrodepositable coating composition of the present invention comprises at least one cathodically electrodepositable resin (A), a crosslinking agent (B) and a catechol derivative (C) of formula (I). The respective ingredients and further components are described below in more detail. Electrodepositable coating compositions are inherently aqueous coating compositions (i.e. water-based coating compositions), since changes in the pH value during the electrodeposition process mandatorily involve the reaction of water at the substrate cathode with electrons, thus producing hydroxide ions and hydrogen.

Since the electrodepositable coating compositions of the present invention comprise at least one cathodically electrodepositable resin (A), the electrodepositable coating compositions are so-called cathodically electrodepositable coating compositions and the coating process is a so-called cathodic electrodeposition coating process.

It is also inherent to the electrodeposition process that no premature curing between the cathodically electrodepositable resin (A) and the crosslinking agent (B) occurs. Therefore, such compositions do not cure at typical coating bath temperatures such as temperatures up to 40° C., but only at more elevated temperatures as for example ≥80° C., more preferably ≥110° C., very preferably ≥130° C., and particularly preferably ≥140° C., such as from 90° C. to 300° C., preferably from 100 to 250° C., more preferably from 125 to 250° C., and most preferably from 150 to 200° C.

Cathodically Electrodepositable Resin (A)

An electrodeposition coating material generally contains a cathodically electrodepositable resin (A) which comprises functional groups that are reactive with a crosslinking agent (B). The functional groups being reactive with the crosslinking agent are preferably hydroxyl groups. Thus, the cathodically electrodepositable resin (A) is preferably a hydroxyl group containing cathodically electrodepositable resin (A).

A variety of such resins are known, including without limitation, epoxy-amine resins, polyesters, polyurethanes, and vinyl resins such as polyacrylate resins, and polybutadiene resins. Many electrocoating applications, including automotive applications, typically use an electrodepositable resin that is cathodically electrodepositable, i.e., it has protonated basic groups (e.g., primary, secondary, or tertiary amine groups) or quaternary groups (e.g., ammonium groups). In a cathodic electrocoating process, the article to be coated is the cathode.

Epoxy-Amine Based Electrodepositable Resins

In a preferred embodiment, the resin is an epoxy resin with amine groups. Amino-epoxy resins (also called epoxy-amine resins) may be prepared from resins having a plurality of epoxide groups, which may be reacted with one or more polyfunctional, preferably difunctional, extender compounds and with one or more amine compounds. Epoxy-amine resins comprise besides the amine groups also hydroxyl groups. The hydroxyl groups are typically formed by an epoxy-ring-opening reaction of the amine compound with the epoxide-groups of the resin having the plurality of epoxide groups. The hydroxyl groups serve as functional groups being reactive with the crosslinking agent (B).

Nonlimiting examples of resins with a plurality of epoxide groups include diglycidyl aromatic compounds such as the diglycidyl ethers of polyhydric phenols such as 2,2-bis(4-hydroxyphenyl)propane (bisphenol A), 2,2-bis(4-hydroxy-3-methylphenyl)-propane, 4,4′-dihydroxybenzophenone, dihydroxyacetophenones, 1,1-bis(4-hydroxyphenylene)ethane, bis(4-hydroxyphenyl) methane, 1,1-bis(4-hydroxyphenyl)-isobutane, 2,2-bis(4-hydroxy-tert-butylphenyl) propane, 1,4-bis(2-hydroxyethyl)-piperazine, 2-methyl-1,1-bis(4-hydroxyphenyl)propane, bis-(2-hydroxynaphthyl)-methane, 1,5-dihydroxy-3-naphthalene, and other dihydroxynaphthylenes, catechol, resorcinol, and the like, including diglycidyl ethers of bisphenol A and bisphenol A-based resins. Also suitable are the diglycidyl ethers of aliphatic diols, including the diglycidyl ethers of 1,4-butanediol, cyclohexanedimethanols, ethylene glycol, propylene glycol, diethylene glycol, dipropylene glycol, triethylene glycol, tripropylene glycol, polypropylene glycol, polyethylene glycol, poly(tetrahydrofuran), 1,3-propanediol, 2,2,4-trimethyl-1,3-pentanediol, 1,6-hexanediol, 2,2-bis(4-hydroxycyclohexyl) propane, and the like.

Diglycidyl esters of dicarboxylic acids can also be used as polyepoxides. Specific examples of compounds include the diglycidyl esters of oxalic acid, cyclohexanediacetic acids, cylcohexanedicarboxylic acids, succinic acid, glutaric acid, phthalic acid, terephthalic acid, isophthalic acid, naphthalene dicarboxylic acids, and the like.

A polyglycidyl reactant may be used, preferably in a minor amount in combination with diepoxide reactant.

Novolac epoxies may be used as a polyepoxide-functional reactant. The novolac epoxy resin may be selected from epoxy phenol novolac resins or epoxy cresol novolac resins.

Other suitable higher-functionality polyepoxides are glycidyl ethers and esters of triols and higher polyols such as the triglycidyl ethers of trimethylolpropane, trimethylolethane, 2,6-bis(hydroxymethyl)-p-cresol, and glycerol; tricarboxylic acids or polycarboxylic acids.

Further, useful as polyepoxides are epoxidized alkenes such as cyclohexene oxides and epoxidized fatty acids and fatty acid derivatives such as epoxidized soybean oil.

Other useful polyepoxides include, without limitation, polyepoxide polymers such as acrylic, polyester, polyether, and epoxy resins and polymers, and epoxy-modified polybutadiene, polyisoprene, acrylobutadiene nitrile copolymer, or other epoxy-modified rubber-based polymers that have a plurality of epoxide groups.

It may also be advantageous to extend the epoxy resin by reacting an excess of epoxide group equivalents with a modifying material, such as a polyol, a polyamine or a polycarboxylic acid, to improve the film properties. Suitable, nonlimiting examples of extender compounds include polycarboxylic acids, polyols, polyphenols, and amines having two or more amino hydrogens, especially dicarboxylic acids, diols, diphenols, and diamines. Nonlimiting examples of suitable extenders include diphenols, diols, and diacids, polycaprolactone diols, and ethoxylated bisphenol A resins such as those available from BASF Corporation under the trademark MACOL®. Other suitable extenders include, without limitation, carboxy- or amine-functional acrylic, polyester, polyether, and epoxy resins and polymers. Still other suitable extenders include, without limitation, polyamines, including diamines such as ethylenediamine, diethylenetriamine, triethylenetetramine, dimethylaminopropylamine, dimethylaminobutylamine, diethylaminopropylamine, diethylaminobutylamine, dipropylamine, and piperizines such as 1-(2-aminoethyl)piperazine, polyalkylene-polyamines such as triethylenetetramine, tetraethylenepentamine, pentaethylene-hexamine, tripropylenetetramine, tetrapropylenepentamine, pentapropylenehexamine, N,N′-bis(3-aminopropyl)ethylenediamine, N-(2-hydroxyethyl) propane-1,3-diamine, and polyoxyalkylene amines such as those available from BASF AG under the trademark POLYAMIN® or from Huntsman under the trademark JEFFAMINE®. The product of the reaction of polyepoxide and extender will be epoxide-functional when excess equivalents of polyepoxide are reacted or will have the functionality of the extender when excess equivalents of extender are used. A monofunctional reactant may optionally be reacted with the polyepoxide resin and the extender or after reaction of the polyepoxide with the extender to prepare the epoxy resin. Suitable, nonlimiting examples of monofunctional reactants include phenol, alkylphenols such as nonylphenol and dodecylphenol, other monofunctional, epoxide-reactive compounds such as dimethylethanolamine and monoepoxides such as the glycidyl ether of phenol, the glycidyl ether of nonylphenol, or the glycidyl ether of cresol, and dimer fatty acid.

Useful catalysts for the reaction of the polyepoxide resin with the extender and optional monofunctional reactant and for the reaction of an epoxide group of the resin with an aliphatic amine group of a compound with an tridentate amine ligand include any that activate an oxirane ring, such as tertiary amines or quaternary ammonium salts (e.g., benzyldimethylamine, dimethylaminocyclohexane, triethylamine, N-methylimidazole, tetramethyl ammonium bromide, and tetrabutyl ammonium hydroxide.), tin and/or phosphorous complex salts (e.g., (CH₃)₃SnI, (CH₃)₄PI, triphenylphosphine, ethyltriphenyl phosphonium iodide, tetrabutyl phosphonium iodide). It is known in the art that tertiary amine catalysts may be preferred with some reactants. The reaction may be carried out at a temperature of from about 100° C. to about 350° C., preferably from about 160° C. to about 250° C. in solvent or neat. Suitable solvents include, without limitation, inert organic solvent such as a ketone, including methyl isobutyl ketone and methyl amyl ketone, aromatic solvents such as toluene, xylene, Aromatic 100, and Aromatic 150, and esters, such as butyl acetate, n-propyl acetate, hexyl acetate.

Amino groups can be incorporated by reacting the polyglycidyl ethers of the polyphenols with amines or polyamines, such as by reaction of the polyepoxide resin with an extender having a tertiary amine group or by reaction with a monofunctional reactant having an amine group. Suitable, nonlimiting examples of extenders and monofunctional reactants having an amine group that may be used include diethanolamine, dipropanolamine, diisopropanolamine, dibutanolamine, diisobutanolamine, diglycolamine, methylethanolamine, dimethylaminopropylamine, diethylaminopropylamine, dimethylaminoethylamine, N-aminoethylpiperazine, aminopropylmorpholine, tetramethyldipropylenetriamine, methylamine, ethylamine, dimethylamine, dibutylamine, ethylenediamine, diethylenetriamine, triethylenetetramine, dimethylaminobutylamine, diethylaminopropylamine, diethylaminobutylamine, dipropylamine, methylbutylamine, methylethanolamine, aminoethylethanolamine, aminopropylmonomethylethanolamine, polyoxyalkylene amines, and compounds having a primary amine group that has been protected by forming a ketimine. Quaternary ammonium groups may be incorporated, and are formed, for example, from a tertiary amine by salinization with an acid, then reacting the hydrogen with, e.g., a compound bearing an epoxide group to produce an ammonium group.

In some embodiments, the epoxide groups on the epoxy resin are reacted with a compound comprising a secondary amine group and at least one latent primary amine. The latent primary amine group is preferably a ketimine group. The primary amines are regenerated when the resin is emulsified.

Epoxy-modified novolacs can be used as a resin in the binder. The epoxy-novolac resin can be capped in the same way as previously described for the epoxy resin.

Polybutadiene, polyisoprene, or other epoxy-modified rubber-based polymers can be used as the resin in the present invention. The epoxy-rubber can be capped with a compound comprising a salifiable amine group.

Other Electrodepositable Resins

Cationic polyurethanes and polyesters may also be used as cathodically electrodepositable resins (A). Such materials may be prepared by endcapping with, for example, an aminoalcohol or, in the case of the polyurethane, the same compound comprising a salifiable amine group previously described may also be useful. The cationic polyurethanes and cationic polyesters preferably comprise hydroxyl groups as functional groups that are reactive with the crosslinking agent (B).

Cationic acrylic resins may also be used. Acrylic polymers may be made cathodic depositable by incorporation of amino-containing monomers, such as N′-dimethylaminoethyl methacrylate, tert-butylaminoethyl methacrylate, 2-vinylpyridine, 4-vinylpyridine, vinylpyrrolidine or other amino monomers. Alternatively, epoxy groups may be incorporated by including an epoxy-functional monomer in the polymerization reaction. Such epoxy-functional acrylic polymers may be made cathodic by reaction of the epoxy groups with amines according to the methods previously described for the epoxy resins. The polymerization may also include a hydroxyl-functional monomer. Useful hydroxyl-functional ethylenically unsaturated monomers include, without limitation, hydroxyethyl methacrylate, hydroxyethyl acrylate, hydroxypropyl acrylate, hydroxypropyl methacrylate, hydroxybutyl acrylate, hydroxybutyl methacrylate, the reaction product of methacrylic acid with styrene oxide, and so on. Preferred hydroxyl monomers are methacrylic or acrylic acid esters in which the hydroxyl-bearing alcohol portion of the compound is a linear or branched hydroxy alkyl moiety.

The monomer bearing the hydroxyl group and the monomer bearing the salifiable group (amine for a cationic group or acid or anhydride for anionic group) may be polymerized with one or more other ethylenically unsaturated monomers. Such monomers for copolymerization are known in the art. Illustrative examples include, without limitation, alkyl esters of acrylic or methacrylic acid, e.g., methyl methacrylate, ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, t-butyl acrylate, t-butyl methacrylate, amyl acrylate, amyl methacrylate, isoamyl acrylate, isoamyl methacrylate, hexyl acrylate, hexyl methacrylate, 2-ethylhexyl acrylate, decyl acrylate, decyl methacrylate, isodecyl acrylate, isodecyl methacrylate, dodecyl acrylate, dodecyl methacrylate, cyclohexyl acrylate, cyclohexyl methacrylate, substituted cyclohexyl acrylates and methacrylates, 3,5,5-trimethylhexyl acrylate, 3,5,5-trimethylhexyl methacrylate, the corresponding esters of maleic, fumaric, crotonic, isocrotonic, vinylacetic, and itaconic acids, and the like; and vinyl monomers such as styrene, t-butyl styrene, alpha-methyl styrene, vinyl toluene and the like. Other useful polymerizable co-monomers include, for example, alkoxyethyl acrylates and methacrylates, acryloxy acrylates and methacrylates, and compounds such as acrylonitrile, methacrylonitrile, acrolein, and methacrolein. Combinations of these are usually employed.

The resin can be emulsified in water in the presence of a salifiable compound. When the resin has basic groups, such as amine groups, the resin is salified with an acid. Usually, the principal resin and the crosslinking agent are blended together before the resins are dispersed in the water. Examples of suitable neutralizing agents for the potentially cationic groups are organic and inorganic acids such as sulfuric acid, phosphoric acid, formic acid, acetic acid, lactic acid, dimethylolpropionic acid, citric acid or sulfonic acids, such as amidosulfonic acids and alkanesulfonic acids, such as methanesulfonic acid, for example, more particularly formic acid, acetic acid or lactic acid. The acid is used in an amount sufficient to neutralize enough of the amine groups of the principal resin to impart water-dispersibility to the resin. The resin may be fully neutralized; however, partial neutralization is usually sufficient to impart the required water-dispersibility. “Partial neutralization” means that at least one, but less than all, of the salifiable groups on the resin are neutralized. By saying that the resin is at least partially neutralized, it is meant that at least one of the salifiable groups on the resin is neutralized, and up to all such groups may be neutralized. The degree of neutralization that is required to afford the requisite water-dispersibility for each resin will depend upon its chemical composition, molecular weight, and other such factors and can readily be determined by one of ordinary skill in the art through straightforward experimentation.

Crosslinking Agents (B)

Besides the at least one cathodically electrodepositable resin (A), the electrodepositable coating material comprises at least one crosslinking agent (B) which permits a crosslinking reaction with the reactive functional groups of the resin (A). Since the reactive functional groups of the cathodically electrodepositable resin (A) are most preferred hydroxyl groups, the crosslinking agents (B) preferably contain groups with react with hydroxyl groups, such as the most preferred blocked polyisocyanates.

All customary crosslinking agents (B) known to the skilled person may be used, such as phenolic resins, polyfunctional Mannich bases, aminoplast resins such as melamine resins and benzoguanamine resins, and particularly preferred blocked polyisocyanates.

Blocked polyisocyanates which can be utilized are any polyisocyanates such as diisocyanates, for example, in which the isocyanate groups have been reacted with a compound and so the blocked polyisocyanate formed is stable in particular with respect to hydroxyl and amino groups, such as primary and/or secondary amino groups, at room temperature, i.e., at a temperature of 23° C., but reacts at elevated temperatures, as for example at ≥80° C., more preferably ≥110° C., very preferably ≥130° C., and particularly preferably ≥140° C., or at 90° C. to 300° C. or at 100 to 250° C., more preferably at 125 to 250° C., and very preferably at 150 to 200° C.

In the preparation of the blocked polyisocyanates it is possible to use any desired organic polyisocyanates that are suitable for crosslinking. Isocyanates used are preferably (hetero)aliphatic, (hetero)cycloaliphatic, (hetero)aromatic, or (hetero)aliphatic-(hetero)aromatic isocyanates. Preferred are diisocyanates which contain 2 to 36, more particularly 6 to 15, carbon atoms. Preferred examples are 1,2-ethylene diisocyanate, 1,4-tetramethylene diisocyanate, 1,6-hexamethylene diisocyanate (HDI), 2,2,4(2,4,4)-trimethyl-1,6-hexamethylene diisocyanate (TMDI), diphenylmethane diisocyanate (MDI), 1,9-diisocyanato-5-methylnonane, 1,8-diisocyanato-2,4-dimethyloctane, 1,12-dodecane diisocyanate, ω,ω′-diisocyanatodipropyl ether, cyclobutene 1,3-diisocyanate, cyclohexane 1,3- and 1,4-diisocyanate, 3-isocyanatomethyl-3,5,5-trimethylcyclohexyl isocyanate (isophorone diisocyanate, IPDI), 1,4-diisocyanatomethyl-2,3,5,6-tetramethylcyclohexane, decahydro-8-methyl-1,4-methanonaphthalen-2 (or 3),5-ylenedimethylene diisocyanate, hexahydro-4,7-methano-indan-1 (or 2),5 (or 6)-ylenedimethylene diisocyanate, hexahydro-4,7-methanoindan-1 (or 2),5 (or 6)-ylene diisocyanate, 2,4- and/or 2,6-hexahydrotolylene diisocyanate (H6-TDI), 2,4- and/or 2,6-tolylene diisocyanate (TDI), perhydro-2,4′-diphenylmethane diisocyanate, perhydro-4,4′-diphenylmethane diisocyanate (H12MDI), 4,4′-diisocyanato-3,3′,5,5′-tetramethyldicyclohexylmethane, 4,4′-diisocyanato-2,2′,3,3′,5,5′,6,6′-octamethyldicyclohexylmethane, ω,ω′-diisocyanato-1,4-diethylbenzene, 1,4-diisocyanatomethyl-2,3,5,6-tetramethyl-benzene, 2-methyl-1,5-diisocyanatopentane (MPDI), 2-ethyl-1,4-diisocyanatobutane, 1,10-diisocyanatodecane, 1,5-diisocyanatohexane, 1,3-diisocyanatomethylcyclohexane, 1,4-diisocyanatomethylcyclohexane, 2,5(2,6)-bis(isocyanatomethyl)-bicyclo[2.2.1]heptane (NBDI), and also any mixture of these compounds.

Particularly preferred are polyisocyanates of higher isocyanate functionality such as trimers, or higher oligomers of the afore-mentioned diisocyanates. Preferably the polyisocyanates are obtained by the reaction of three or more diisocyanates and comprise one or more groups selected from isocyanurate groups, iminooxadiazine dione groups, uretdione groups, biuret groups, allophanate groups, urethane groups and urea groups.

Furthermore, mixtures of polyisocyanates may also be utilized. The organic polyisocyanates contemplated as crosslinking agents (B) for the invention may also be prepolymers, deriving, for example, from a polyol, including from a polyether polyol or a polyester polyol.

In the synthesis of the blocked diisocyanates or blocked polyisocyanates, the isocyanate groups of above diisocyanates or polyisocyanates are reacted with a blocking agent to become “blocked isocyanate” groups.

Blocking agents for preparing the blocked polyisocyanates are for example
i. phenols, pyridinols, thiophenols and mercaptopyridines, preferably selected from the group consisting of phenol, cresol, xylenol, nitrophenol, chlorophenol, ethylphenol, t-butylphenol, hydroxybenzoic acid, esters of this acid, 2,5-di-tert-butyl-4-hydroxytoluene, thiophenol, methylthiophenol and ethylthiophenol;
ii. alcohols and mercaptanes, the alcohols preferably being selected from the group consisting of methanol, ethanol, n-propanol, isopropanol, n-butanol, isobutanol, t-butanol, n-amyl alcohol, t-amyl alcohol, lauryl alcohol, ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether, diethylene glycol monobutyl ether, propylene glycol monomethyl ether, methoxy methanol, 2-(hydroxyethoxy)phenol, 2-(hydroxypropoxy)phenol, glycolic acid, glycolic esters, lactic acid, lactic esters, methylol urea, methylol melamine, diacetone alcohol, ethylene chlorohydrin, ethylene bromohydrin, 1,3-dichloro-2-propanol, 1,4-cyclohexyldimethanol or acetocyano hydrin, and the mercaptanes preferably being selected from the group consisting of butyl mercaptane, hexyl mercaptane, t-butyl mercaptan, t-dodecyl mercaptane;
iii. oximes, preferably the ketoximes of the groups consisting of the ketoxime of tetramethylcyclobutanedione, methyl n-amyl ketoxime, methyl isoamyl ketoxime, methyl 3-ethylheptyl ketoxime, methyl 2,4-dimethylpentyl ketoxime, methyl ethyl ketoxime, cyclohexanone oxime, methyl isopropyl ketoxime, methyl isobutyl ketoxime, diisobutyl ketoxime, methyl t-butyl ketoxime, diisopropyl ketoxime and the ketoxime of 2,2,6,6-tetramethylcyclohexanone; or the aldoximes, preferably from the group consisting of formaldoxime, acetaldoxime;
iv. amides, cyclic amides and imides, preferably selected from the group consisting of lactams, such as ε-caprolactam, δ-valerolactam, γ-butyrolactam or β-propiolactam; acid amides such as acetoanilide, acetoanisidinamide, acrylamide, methacrylamide, acetamide, stearamide or benzamide; and imides such as succinimide, phthalimide or maleimide;
v. imidazoles and amidines;
vi. pyrazoles and 1,2,4-triazoles, such as 3,5-dimethylpyrazole and 1,2,4-triazole;
vii. amines and imines such as diphenylamine, phenylnaphthylamine, xylidine, N-phenylxylidine, carbazole, aniline, naphthylamine, butylamine, dibutylamine, butylphenylamine and ethyleneimine;
viii. imidazoles such as imidazole or 2-ethylimidazole;
ix. ureas such as urea, thiourea, ethyleneurea, ethylenethiourea or 1,3-diphenylurea;
x. active methylene compounds such as dialkyl malonates like diethyl malonate, and acetoacetic esters; and
xi. others such as hydroxamic esters as for example benzyl methacrylohydroxamate (BMH) or allyl methacrylohydroxamate, and carbamates such as phenyl N-phenylcarbamate or 2-oxazolidone.

Amongst the above blocking agents, the oximes (group iii.), particularly methyl ethyl ketoxime and the pyrazoles (group vi.), particularly 3,5-dimethylpyrazole are most preferred.

The blocking agents of group x. do not react in a deblocking reaction at elevated temperature, but in a transesterification of the ester groups present therein, when reacted with alcohols, particularly polyols.

Catechol Derivatives (C)

The electrodeposition coating material according to the present invention contains at least one catechol derivative (C) represented by formula (I)

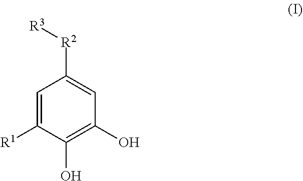

wherein

R¹ is H or OH;

R² is a divalent radical selected from the group consisting of *C(O)—O, (HO)*CH—CH₂ or *CH₂—CH₂, with * denoting the carbon atom which is bound to the benzene ring; and

R³ is a monovalent radical selected from the group consisting of NH₂, (H₃N⁺)X⁻, NHR⁴, (⁺NH₂R⁴)X⁻, or R⁴, wherein X is the anion of an organic or inorganic acid and

R⁴ a linear or branched alkyl group having 1 to 6 carbon atoms, preferably 2 to 4, such as 2 or 3 carbon atoms.

The common structure of all claimed compounds of formula (I) is

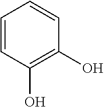

which is the structure of catechol, therefore the compounds of formula (I) are depicted as catechol derivatives.

Amongst the catechol derivatives those being water soluble are preferred, because they can be dissolved homogeneously in the aqueous electrodeposition coating material of the present invention. Water solubility in this context means that the total amount of the compounds of formula (I) employed in the electrodeposition coating material is completely dissolved at bath temperature.

Amongst the catechol derivatives (C) represented by formula (I) compounds selected from the group consisting of protocatechuic acid esters such as propyl gallate and 3,4-dihydroxybenzoic acid ethyl ester; and catecholamines, such as dopamine and isoproterenol and their salts, are particularly preferred. In the context of this disclosure gallic acid is a special embodiment of protocatechuic acid, namely a 5-hydroxy protocatechuic acid.

In protocatechuic acid ester derivatives R¹═H or OH; R²═*C(O)—O; and R³═R⁴, while

in catecholamines=H; R²═(HO)*CH—CH₂ or *CH₂—CH₂; and R³═NH₂, (H₃N⁺) NHR⁴ or (⁺NH₂R⁴)X⁻, the definitions of R¹, R², R³, R⁴ and X being as described before.

Preferably, R¹═H or OH; R²═*C(O)—O or *CH₂—CH₂, with * denoting the carbon atom which is bound to the benzene ring and R³=Ethyl or Propyl.

Most preferred catechol derivatives (C) of formula (I) of the present invention are the protocatechuic acid esters. Amongst those, such protocatechuic acid esters are even more preferred, where R¹═H or OH; R²═*C(O)—O; and R³=Ethyl or Propyl,

It was surprisingly found that the catechol derivatives (C) or formula (I), although they contain at least two hydroxyl groups and in case of the catecholamines additionally at least one nitrogen bound hydrogen atom, and are therefore potentially reactive with the afore-mentioned crosslinking agents (B) under crosslinking conditions, are apt to significantly improve anticorrosive properties of the electrodeposition coating material of the present invention, preferably at a concentration from 200 to 4000 ppm, and even at rather low amounts preferably ranging from 250 ppm to 3500 ppm, based on the total weight of the electrodeposition coating material. In the present invention “ppm” stands for weight parts per million and is calculated based the amount of the formula weight of the compound (in case of catecholamines calculated in form of their hydrochlorides), and the total weight of the electrodepositable coating material. More preferred the amount of catechol derivatives (C) represented by formula (I) ranges from 300 ppm to 3000 ppm, even more preferred from 400 ppm to 2800 ppm, and most preferred from 500 ppm to 2500 ppm, based on the total weight of the electrodeposition coating material.

If just corrosion protection of aluminum-based substrates is needed, the ppm ranges above are suitable ranges. Using less of the catechol derivatives (C) of formula (I), may lead to lesser corrosion protection and using more than the upper limits disclosed above does typically not provide for further corrosion protection on aluminum-based substrates.

If corrosion protection on other substrates such as steel (e.g. cold rolled steel) or zinc-coated substrates (e.g. hot-dip galvanized steel) is required, it is advisable to increase the lower range limits. In such cases, preferably 600 to 3000 ppm, more preferred 800 ppm to 2800 ppm, and even more preferred 1000 ppm to 2500 ppm and most preferred 1100 ppm to 2400 ppm such as 1200 ppm to 2300 ppm of the catechol derivative (C) of formula (I) are employed in the electrodeposition coating material of the present invention, based on the total weight of the electrodeposition coating material.

If corrosion protection of aluminum-based substrates and other substrates such as steel (e.g. cold rolled steel) or zinc-coated substrates (e.g. hot-dip galvanized steel) is required in one electrodeposition bath, it is preferred to employ the catechol derivatives (C) of formula (I) in an amount from preferably 600 to 3000 ppm, more preferred 800 ppm to 2800 ppm, and even more preferred 1000 ppm to 2500 ppm and most preferred 1100 ppm to 2400 ppm such as 1200 ppm to 2300 ppm based on the total weight of the electrodeposition coating material. The afore-mentioned amounts are particularly suitable, if the substrate is a multi-metal substrate comprising surface areas of different metal composition, or if different metallic substrates are to be coated one after the other in the same electrodeposition coating material.

The compounds of formula (I) can either be dissolved directly in the electrodeposition coating material or pre-dissolved in an aqueous medium such as water or in a pigment paste. In some cases, it is advisable to pre-dissolve the catechol derivatives of formula (I) in aqueous medium such as water having a temperature from 20 to 55° C. before adding it to the electrodeposition bath.

Pigments (D) and/or Fillers (D)

It is preferred that the electrodepositable coating material of the present invention contains one or more pigments and/or fillers (D).

Pigments and/or fillers (D) of this kind, present in the electrodepositable coating material, are preferably selected from the group consisting of organic and inorganic, color-imparting and extending pigments.

This at least one pigment and/or filler (D) may be present as part of the aqueous solution or dispersion which is used for preparing the electrodepositable coating material and which comprises the components (A) and (B).

The at least one pigment and/or filler (D) may alternatively be incorporated into the electrodepositable coating material, in the form of a further aqueous dispersion or solution, different from the one used. In this embodiment, the corresponding pigment-containing aqueous dispersion or solution may further comprise at least one resin.

Examples of suitable inorganic color-imparting pigments (D) are white pigments such as zinc oxide, zinc sulfide, titanium dioxide, antimony oxide, or lithopone; black pigments such as carbon black, iron manganese black, or spinel black; chromatic pigments such as cobalt green or ultramarine green, cobalt blue, ultramarine blue or manganese blue, ultramarine violet or cobalt violet and manganese violet, red iron oxide, molybdate red, or ultramarine red; brown iron oxide, mixed brown, spinel phases and corundum phases; or yellow iron oxide, nickel titanium yellow, or bismuth vanadate. Examples of suitable organic color-imparting pigments (D) are monoazo pigments, disazo pigments, anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments, or aniline black. Examples of suitable extending pigments (D) or fillers (D) are chalk, calcium sulfate, barium sulfate, silicates such as talc or kaolin, silicas, oxides such as aluminum hydroxide or magnesium hydroxide, or organic fillers such as textile fibers, cellulose fibers, polyethylene fibers, or polymer powders; for further details, refer to Römpp Lexikon Lacke and Druckfarben, Georg Thieme Verlag, 1998, pages 250 ff., “Fillers”.

The pigment content of the electrodepositable coating material may vary according to the nature of pigments and/or fillers (D). The amount, based in each case on the total weight of the electrodepositable coating material, is preferably in the range from 0.1 to 30 wt % or in the range from 0.5 to 20 wt %, more preferably in the range from 1.0 to 15 wt %, very preferably in the range from 1.5 to 10 wt %, and more particularly in the range from 2.0 to 5.0 wt %, or in the range from 2.0 to 4.0 wt %, or in the range from 2.0 to 3.5 wt %.

Water and Organic Solvents (E)

The electrodepositable coating material is aqueous, meaning that water is comprised as liquid diluent.

The term “aqueous” as used with the electrodepositable coating material refers preferably to an electrodepositable coating material which comprise water as the main component of their liquid diluent, i.e., as liquid solvent and/or dispersion medium.

Optionally, however, the electrodepositable coating material may include at least one organic solvent in minor fractions. Examples of such organic solvents include heterocyclic, aliphatic or aromatic hydrocarbons, mono- or polyhydric alcohols, especially methanol and/or ethanol, ethers, esters, ketones, and amides, such as, for example, N-methylpyrrolidone, N-ethylpyrrolidone, dimethyl-formamide, toluene, xylene, butanol, ethyl glycol and butyl glycol and also their acetates, butyl diglycol, diethylene glycol dimethyl ether, cyclohexanone, methyl ethyl ketone, methylisobutyl ketone, acetone, isophorone, or mixtures thereof. The fraction of these organic solvents is preferably not more than 20.0 wt %, more preferably not more than 15.0 wt %, very preferably not more than 10.0 wt %, more particularly not more than 5.0 wt % or not more than 4.0 wt % or not more than 3.0 wt %, more preferably still not more than 2.5 wt % or not more than 2.0 wt % or not more than 1.5 wt %, most preferably not more than 1.0 wt % or not more than 0.5 wt %, based in each case on the total fraction of the liquid diluents—i.e., liquid solvents and/or dispersion media—that are present in the electrodepositable coating material.

Fractions in % by weight of all components included in the electrodepositable coating material of the invention, in other words the fractions of (A), (B), (C), (D), (E) and (F) preferably add up to 100 wt %, based on the total weight of electrodepositable coating material.

The electrodepositable coating material preferably has a solids content in the range from 5 to 45 wt %, more preferably in the range from 7.5 to 35 wt %, very preferably from 10 to 30 wt %, more preferably still in the range from 12.5 to 25 wt %, based in each case on the total weight of the electrodepositable coating material. Methods for determining the solids content are known to the skilled person. The solids content is determined preferably according to DIN EN ISO 3251 (date: Jun. 1, 2008) by drying the coating composition for 30 min at a temperature of 180° C.

Further Ingredients (F) and/or Additives (F)

Depending on desired application, the electrodepositable coating material may comprise one or more typically employed additives (F). These additives (F) are preferably selected from the group comprising or consisting of edge protection agents, wetting agents, emulsifiers, dispersants, surface-active compounds such as surfactants, flow control assistants, solubilizers, defoamers, rheological assistants, antioxidants, stabilizers, preferably heat stabilizers, in-process stabilizers, and UV and/or light stabilizers, catalysts, fillers, waxes, flexibilizers, plasticizers, and mixtures of the abovementioned additives. The additive content may vary very widely according to intensive use. The amount, based on the total weight of the electrodepositable coating material, is preferably 0.1 to 20.0 wt %, more preferably 0.1 to 15.0 wt %, very preferably 0.1 to 10.0 wt %, especially preferably 0.1 to 5.0 wt %, and more particularly 0.1 to 2.5 wt %.

pH Value of the Electrodepositable Coating Material

The electrodepositable coating material of the invention preferably has a pH in a range from 4.0 to 6.5. The electrodepositable coating material used in accordance with the invention more preferably has a pH in the range from 4.5 to 6.5, more particularly in the range from 5.0 to 6.0 or in the range from 5.2 to 5.8, and most preferably in the range from 5.3 to 5.5. Methods for adjusting pH levels in aqueous compositions are known to the skilled person. The desired pH is preferably set by addition of at least one acid, more preferably at least one inorganic and/or at least one organic acid. Examples of suitable inorganic acids are sulfuric acid and/or nitric acid, less preferred phosphoric acid. Examples of a suitable organic acids are propionic acid, lactic acid, acetic acid and/or formic acid.

Method of the Invention

The method of coating a metallic substrate comprising the steps of
a. dipping a metallic substrate into an electrodeposition bath containing the electrodepositable coating material as claimed herein;
b. switching the substrate as a cathode;
c. depositing the electrodepositable coating material onto the substrate to form a coating layer; and
d. spray or dip cleaning of the coated substrate; and
e. drying and curing the thus formed coating layer.

Thus, the above method of coating a metallic substrate is a cathodic electrodeposition coating process.

These steps and any optional cleaning or pre-treatment steps will be explained in more detail in the following.

Prior to carrying out step a. the metallic substrate is preferably cleaned and/or degreased. The term “metallic substrate” as used in this specification applies to any kind of metallic, electrically conductive substrate having a two- or three-dimensional form. Preferred substrates are steel, such as cold-rolled steel; hot-dip galvanized steel, wherein the hot-dip composition used for galvanizing the steel substrate preferably contains zinc, such as an ZnAl alloy or ZnAlMg alloy; and aluminum and its alloys.

The cleaning and/or degreasing procedure preferably comprises at least one of cleaning and degreasing. The solutions used for cleaning and/or degreasing are preferably aqueous and can be acidic, alkaline or neutral. They may further contain tensides and/or chelating agents. Preferably degreasing is carried out with an alkaline aqueous solution.

If a cleaning and/or degreasing step is carried out, the thus treated metallic substrate is preferably rinsed with water before carrying out step a.

Step a.

The electrodeposition bath contains the electrodepositable coating material according to the invention. Preferably the temperature of the electrodepositable coating material according to the invention is in the range from 25 to 40° C., more preferred 32±3° C.

Step b.

In this step, the metallic substrate is switched as a cathode. The preferred voltage is from 200 to 250 V.

Step c.

During a period of preferably 30 s to 300 s, more preferred 60 s to 200 s and most preferred 90 s to 150 s, such as 110 to 130 s the electrodeposition takes place thus forming a coating layer. Preferred dry layer thicknesses are from 10 to 40 μm, more preferred 15 to 30 μm and most preferred 18 to 25 μm.

Step d.

After depositing the coating material, the coating layer formed in step c. is spray-cleaned or dip-cleaned, preferably with water.

Step e.

Afterwards the coating layer is dried and cured. The curing temperature and time depends on the electrodepositable resin(s) (A) and the crosslinking agents (B) as well as any catalysts that may be used in the electrodepositable coating material for crosslinking. Preferably the curing temperature is in the range from 120 to 200° C., more preferred 140 to 190° C. and most preferred 150 to 180° C. The curing time, including the heating phase of the coated substrate from about room temperature (23° C.) to the curing temperature, preferably ranges from 15 to 60 min, more preferred 20 to 45, such as 25 to 35 min. The heating phase can vary, but is suitably about 10 min.

Use of the Invention

The use of the invention is the use of one or more compounds represented by formula (I)

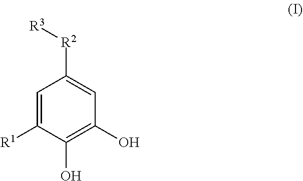

wherein

R¹ is H or OH;

R² is a divalent radical selected from the group consisting of *C(O)—O, (HO)*CH—CH₂ or *CH₂—CH₂, with * denoting the carbon atom which is bound to the benzene ring; and

R³ is a monovalent radical selected from the group consisting of NH₂, (H₃N⁺)X⁻; NHR⁴, (⁺NH₂R⁴)X⁻, or R⁴, wherein X is the anion of an organic or inorganic acid and

R⁴ a linear or branched alkyl group having 1 to 6 carbon atoms, preferably 2 to 4, such as 2 or 3 carbon atoms,

as anticorrosion agents in electrodeposition coating materials.

Any of the preferred embodiments of the compounds according to formula (I) as disclosed in the specification are also preferred embodiments in the use of the invention.

The electrodeposition coating materials, to which the use of the invention refers, preferably comprise the ingredients as disclosed above for the electrodepositable coating material of the present invention.

Particularly preferred, the one or more compounds represented by formula (I) are used in the electrodeposition coating material in a total amount from 200 to 4000 ppm, more preferred 250 to 3500 ppm and most preferred 300 to 3000 ppm, based on the total weight of the electrodeposition coating material.

The preferred ranges as described above for different types of substrates under the headline “Catechol derivatives (C)”, also apply to the use of the invention.

Coated Substrates of the Invention

The coated substrate of the invention is a coated metallic substrate obtained in the method according to the invention. The coated substrate can be a multilayer coated substrate, wherein preferably the first coating layer on the metallic substrate is formed according to the method of the present invention.

Subsequent to such preferably first coating layer, in the following order, preferably one or more filler layers, preferably followed by one or more basecoat layers and again preferably followed by one or more clearcoat layers may be applied. Filler layer(s) and/or basecoat layer(s) and/or clearcoat layer(s) can be applied wet-on-wet-on-wet. However, it is also possible to first cure the filler layer(s), before applying the basecoat layer(s) and/or clearcoat layer(s) wet-on-wet; or curing filler layer(s) and/or basecoat layer(s) and/or clearcoat layer(s) independently of each other.

Preferred metallic substrates are for example automotive bodies and parts thereof. The parts may be single parts made from one metal or alloy or pre-assembled parts made from one or more metals and/or alloys.

Further preferred metallic substrates are cold rolled steel, electrogalvanized and hot dip galvanized steel, aluminum (preferably the 6000 series), zinc-magnesium-aluminum galvanized steel and aluminum-silicon-zinc galvanized steel such as Galvalume® (BIEC International, Inc.).

The examples, which follow, serve to elucidate the invention, but should not be interpreted as imposing any restriction.

Unless otherwise noted, the figures in percent hereinafter are in each case percentage values by weight.

### Examples

Corrosion Test Procedures

Neutral Salt Spray Test (NSS Test)

The NSS test is used for determining the corrosion resistance of a coating on a substrate. In accordance with DIN EN ISO 9227 NSS (date: Sep. 1, 2012), the NSS test is carried out for an electrically conductive substrate coated with an inventive coating composition or with a comparative coating composition. In this test, the samples under analysis are in a chamber in which there is continuous misting with a 5% strength common salt solution at a temperature of 35° C. over a duration of 1008 hours at a controlled pH in the range from 6.5 to 7.2. The mist deposits on the samples under analysis, covering them with a corrosive film of salt water. If, still prior to NSS test to DIN EN ISO 9227 NSS, the coating on the samples under analysis is scored down to the substrate with a blade incision (Scratch Master 1 mm blade, 75 μm), the samples can be investigated for their level of under-film corrosion (undermining) to DIN EN ISO 4628-8 (date: Mar. 1, 2013), since the substrate corrodes along the score line during the DIN EN ISO 9227 NSS test. This investigation takes place after the NSS test has been carried out for a duration of 1008 hours. As a result of the progressive process of corrosion, the coating is undermined to a greater or lesser extent during the test. The extent of undermining in [mm] is a measure of the resistance of the coating to corrosion. The values are average values of 3 panels.

VDA New Climate Change Test (VDA New Test; VDA 233-102 Test)

The VDA New test is used for determining the corrosion resistance of a coating on a substrate. In accordance with DIN 55635 (May 2019), the VDA new test is carried out for an electrically conductive substrate coated with an inventive coating composition or with a comparative coating composition. The alternating climate test here is carried out in 6 cycles. One cycle here consists of a total of 168 hours (1 week) and encompasses three phases that represent 24 hours of the cycle time. The three phases are characterized as follows.
a) Salt spray phase (A): 3 hours of salt spray mist (1% NaCl solution; 35° C.; 100% relative humidity)
b) Observation phase (B): 3 hours 25° C., 70% relative humidity
c) Low temperature phase (C): 1 hour −2.5° C.; 6 hours −15° C. and 1 hour −2° C.; no regulation of the relative humidity

The test cycle is formed by the combination of the three phases in the following order:

B A C A B B A

The respective coating on the samples under investigation is scored down to the substrate with a bladed incision prior to the implementation of the alternating climate test, thus allowing the samples to be investigated for their level of under-film corrosion (undermining) to DIN EN ISO 4628-8 (date: Mar. 1, 2013), since the substrate corrodes along the score line during the performance of the alternating climate test. As a result of the progressive process of corrosion, the coating is undermined to a greater or lesser extent during the test. The degree of undermining in [mm] is a measure of the resistance of the coating to corrosion. The average undermining level stated in the results later on below represents the average value of the individual values from three to five different panels assessed, with each individual value for a panel in turn being an average value of the undermining levels at 11 measurement points on the panel.

VDA Climate Change Test (VDA Test)

The VDA test is used for determining the corrosion resistance of a coating on a substrate. In accordance with DIN EN ISO 11997-1 (January 2018, cycle B), the VDA test is carried out for an electrically conductive substrate coated with an inventive coating composition or with a comparative coating composition. The alternating climate test here is carried out in 10 cycles. One cycle here consists of a total of 168 hours (1 week) and encompasses
a) 24 hours of salt spray mist testing as per DIN EN ISO 9227 NSS (date: June, 2017),
b) followed by 8 hours of storage, including heating, as per DIN EN ISO 6270-2 of September 2005, AHT method,
c) followed by 16 hours of storage, including cooling, as per DIN EN ISO 6270-2 of September 2005, AHT method,
d) 3-fold repetition of b) and c) (hence in total 72 hours), and
e) 48 hours of storage, including cooling, with an aerated climate chamber as per DIN EN ISO 6270-2 of September 2005, AHT method.

The respective coating on the samples under investigation is scored down to the substrate with a bladed incision prior to the implementation of the alternating climate test, thus allowing the samples to be investigated for their level of under-film corrosion (undermining) to DIN EN ISO 4628-8 (date: Mar. 1, 2013), since the substrate corrodes along the score line during the performance of the alternating climate test. As a result of the progressive process of corrosion, the coating is undermined to a greater or lesser extent during the test. The degree of undermining in [mm] is a measure of the resistance of the coating to corrosion. The average undermining level stated in the results later on below represents the average value of the individual values from three to five different panels assessed, with each individual value for a panel in turn being an average value of the undermining levels at 11 measurement points on the panel.

Climate Change Test PV1210 (PV1210 Test)

This climate change test is used to determine the corrosion resistance of a coating on a substrate. The climate change test is carried out in 30 so-called cycles. Prior to the PV1210 test, the coating of the specimens to be tested is scored down to the substrate with a knife cut (Scratch Master 1 mm blade, 75 μm) before the climate change test is performed, the specimens can be tested for their degree of under-film corrosion in accordance with DIN EN ISO 4628-8 (03-2013), since the substrate corrodes along the scoring line during the climate change test. As corrosion progresses, the coating is more or less infiltrated during the test. The degree of undermining in [mm] is a measure of the resistance of the coating. The values are average values of 3 panels.

This alternating climate test PV 1210 is used for determining the corrosion resistance of a coating on a substrate. The alternating climate test is carried out for corresponding coated electrically conductive substrates composed of hot-dip-galvanized steel (HDG). The alternating climate test here is carried out in 30 cycles. One cycle (24 hours) here consists of 4 hours of salt spray mist testing as per DIN EN ISO 9227 NSS (June 2017), 4 hours of storage, including cooling as per DIN EN ISO 6270-2 of September 2005 (AHT method) and 16 hours of storage, including heating, as per DIN EN ISO 6270-2 of September 2005, AHT method, at 40±3° C. and at atmospheric humidity of 100%. After each 5 cycles there is a pause of 48 hours, including cooling, as per DIN EN ISO 6270-2 of September 2005, AHT method. 30 cycles therefore correspond to a total duration of 42 days.

The respective coating on the samples under investigation is scored down to the substrate with a bladed incision prior to the implementation of the alternating climate test, thus allowing the samples to be investigated for their level of under-film corrosion (undermining) to DIN EN ISO 4628-8 (date: Mar. 1, 2013), since the substrate corrodes along the score line during the performance of the alternating climate test. As a result of the progressive process of corrosion, the coating is undermined to a greater or lesser extent during the test. The degree of undermining in [mm] is a measure of the resistance of the coating to corrosion. The average undermining level stated in the results later on below represents the average value of the individual values from three to five different panels assessed, with each individual value for a panel in turn being an average value of the undermining levels at 11 measurement points on the panel.

Filiform Corrosion Test (FFC Test)

Determining the filiform corrosion is used to ascertain the corrosion resistance of a coating on a substrate. This determination is carried out according to DIN EN 3665 (08-1997) over a duration of 1008 hours. In the course of this time, the coating in question, starting from a line of induced damage to the coating (Scratch Master 1 mm blade, 75 μm), is undermined by corrosion that takes the form of a line or thread. The maximum and average thread lengths in [mm] are measured. The values are average values over 3 samples (averages of measurements carried out on cuts in lateral direction and cuts in longitudinal direction).

Copper Accelerated Salt Spray Test (CASS Test)

The CASS test is used for determining the corrosion resistance of a coating on a substrate. In accordance with DIN EN ISO 9227 (09-2012) the samples under analysis are in a chamber in which there is continuous misting of a 5% strength common salt solution, the salt solution being admixed with acetic acid and copper chloride, at a temperature of 50° C. over a duration of 240 hours with controlled pH. The spray mist deposits on the samples under analysis, covering them with a corrosive film of salt water. Prior to the CASS test, the coating on the samples for investigation is scored down to the substrate with a blade incision (Scratch Master 1 mm blade, 75 μm). The samples are investigated for their level of under-film corrosion in accordance with DIN EN ISO 4628-8 (03-2013), since the substrate corrodes along the score line during the CASS test. As a result of the progressive process of corrosion, the coating is undermined to a greater or lesser extent during the test. The extent of undermining in [mm] is a measure of the resistance of the coating. The values are average values of 3 panels.

Preparation of Catechol Derivative Containing Electrodeposition Coating Materials

The catechol derivative containing electrodeposition coating materials were prepared by dispersing a pigment paste (BASF SE, Ludwigshafen, Germany) into a commercially available epoxy-resin based electrodeposition coating material (Cathoguard® 800; BASF SE, Ludwigshafen, Germany).

The ingredients of the electrodeposition coating material are shown in Table 1

TABLE 1
Electrodeposition Coating Material
(Electrodeposition Bath)

| | | Amount in |
|---|---|---|
| | | parts by |
| Position | Ingredient | weight |
| 1 | Cathoguard ® 800* | 42.20 |
| 2 | pigment paste | 6.10 |
| 3 | water | 51.20 − x |
| 4 | Catechol derivative | x |
| 5 | edge protection agent | 0.50 |

100.00

*obtainable from BASF SE, Ludwigshafen, Germany

First, positions 1 and 2 of Table 1 were mixed. Further position 4 was dissolved in position 3 and the thus obtained solution was added with position 5 to the mixture of positions 1 and 2 to obtain the catechol derivative containing electrodeposition coating materials having a solids content of 20 wt.-%. Before use, the mixture was stirred for 24 hours. In case the catechol derivative is a protocatechuic acid ester, position 4 was dissolved at an elevated temperature (25 to 50° C.) in water. After cooling to room temperature (20° C.) the protocatechuic acid ester remained dissolved.

The electrodeposition bathes prepared had a pH value in the range of 5.1 to 5.4 and a conductivity in the range of 2.1 to 2.2. The amounts of catechol derivatives used in Table 2 ranged from x=0.05 to 0.3 g, i.e. 500 to 3500 ppm, depending on the catechol derivative examined.

For each case, one bath was prepared as a comparative bath, i.e. the amount of catechol derivative was 0 ppm (x=0).

Application of Catechol derivative Containing Electrodeposition Coating Materials to Metal Panels

The test panels (cold rolled steel (CRS), hot-dip galvanized steel (HDG) and aluminum AA6014) were cleaned by dipping into a bath containing a water-based cleaning solution available as Gardoclean® S5160 from Chemetall GmbH (Frankfurt, Germany) and water (97.7 wt.-%) for 2 min at a temperature of 60° C. After cleaning the panels were spray-cleaned with water and then directly used for electrodeposition coat application.

For electrodeposition coating the panels were dipped into the respective electrodeposition bathes and were used as cathodes in the process. The bath temperature was 32° C. The application was run potentiostatically at a fixed voltage (in the range of 220 to 240 V) that was suitable to obtain a dry film thickness of 20 μm within 2 min application time. After coating, the panels were spray-cleaned with water and cured for 25 min at 175° C. in an oven.

Subsequently, the thus prepared coated test panels were subject to one or more of the corrosion test procedures as described above.

Results of the Corrosion Test Procedures

In Table 2A the test results from corrosion testing of the test panels prepared from 3,4-dihydroxy benzoic acid ethyl ester containing electrodeposition coating materials are summarized.

TABLE 2A
Undermining [mm]

| | | 3,4-dihydroxy benzoic acid ethyl ester amount | | | | |
|---|---|---|---|---|---|---|
| Panel | Test | in electrodeposition bath in ppm | | | | |
| Material | Procedure | 0 | 500 | 1000 | 2000 | 2500 |
| CRS | NSS | 6.2 | 5.7 | 5.5 | 5.6 | 5.8 |
| | VDA new | 9.0 | ND | 9.1 | 6.0 | 3.5 |
| | VDA | 10.0 | 6.2 | 7.8 | 6.4 | 5.7 |
| Aluminum | FFC | 12.0 | 2.1 | 4.7 | 3.2 | 3.4 |
| | CASS | 158 | 67 | 47 | 5 | 1 |
| | (number of | | | | | |
| | blisters) | | | | | |

ND = not determined

The results in Table 2A clearly show that the aim of providing corrosion protection on different substrates, particularly CRS and aluminum was achieved with 3,4-dihydroxy benzoic acid ethyl ester containing electrodeposition coating materials.

In Table 2B the test results from corrosion testing of the test panels prepared from propyl gallate containing electrodeposition coating materials are summarized.

TABLE 2B
Undermining [mm]

| | | propyl gallate amount in | | | | | |
|---|---|---|---|---|---|---|---|
| Panel | Test | electrodeposition bath in ppm | | | | | |
| Material | Procedure | 0 | 500 | 1000 | 1500 | 2000 | 2500 |
| CRS | NSS | 6.1 | 7.1 | 7.9 | 6.1 | 5.1 | 3.5 |
| | VDA | 8.3 | 9.1 | 9.4 | 7.4 | 5.6 | 6.2 |
| HDG | PV1210 | 8.2 | 8.9 | 7.2 | 7.3 | 5.5 | 5.5 |
| | VDA | 5.9 | 6.7 | 6.0 | 5.5 | 4.5 | 12 |
| Aluminum | FFC | 6.1 | 3.2 | 2.3 | 1.8 | 1.5 | 1.5 |

It is evident from the results in Table 2B that the aim of providing corrosion protection on different substrates, particularly CRS, HDG and aluminum was achieved with propyl gallate containing electrodeposition coating materials.

Interestingly, it was found for 3,4-dihydroxy benzoic acid ethyl ester (Table 2A) as well as propyl gallate (Table 2B) that the performance is best on aluminum-based substrates, even at very low amounts of the respective catechol derivative, while at higher amounts as e.g. 2000 and 2500 ppm the corrosion protecting effect on aluminum seems to stagnate.

On CRS and HDG, the sample containing a very low amount of the respective catechol derivative, such a 500 ppm, does not provide an additional corrosion protection and might in some cases even be slightly inferior compared to the comparative bath, while higher amounts of 1000 ppm and above clearly show an increased corrosion protection.

Therefore, in general, if only corrosion protection of aluminum-based substrates is needed, employing low amounts of the respective catechol derivatives is sufficient. If also protection is sought for HDG and/or CRS, it is advisable to use amounts preferably higher than 500 ppm or even more preferred higher than 1000 ppm up to less than 3000 ppm of the respective catechol derivative, based on the total weight of the electrodeposition coating material.

Results with a similar, but weaker tendency were obtained for isoproterenol hydrochloride and dopamine hydrochloride, particularly on aluminum substrates in the FFC and CASS tests.

In summary, it was found by the inventors that the electrodeposition coating materials according to the invention are apt to reduce corrosion on aluminum, but also, to a lesser extent, on other substrates, thus providing corrosion inhibition in multi-metal substrate coating applications.

1. An electrodepositable coating material comprising
i. one or more cathodically electrodepositable resins (A);
ii. one or more crosslinking agents (B); and
iii. one or more compounds represented by formula (I) 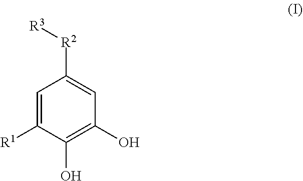
wherein
R¹ is H or OH;
R² is a divalent radical selected from the group consisting of *C(O)—O, (HO)*CH—CH₂ and *CH₂—CH₂, with * denoting the carbon atom which is bound to the benzene ring; and
R³ is a monovalent radical selected from the group consisting of NH₂, (H₃N⁺)X⁻, NHR⁴, (⁺NH₂R⁴)X⁻, and R⁴, wherein X is the anion of an organic or inorganic acid and R⁴ a linear or branched alkyl group having 1 to 6 carbon atoms.

2. The electrodepositable coating material according to claim 1, wherein the electrodepositable coating material is aqueous and has a pH value in a range from 4.0 to 6.5.

3. The electrodepositable coating material according to claim 1, wherein the one or more cathodically electrodepositable resins (A) are selected from the group consisting of cathodically electrodepositable epoxy-based resins and cathodically electrodepositable polyacrylate resins.

4. The electrodepositable coating material according to claim 1, wherein the one or more crosslinking agents (B) are selected from the group consisting of blocked diisocyanates, blocked polyisocyanates and aminoplast resins.

5. The electrodepositable coating material according to claim 1, wherein the one or more compounds of formula (I) are selected from the group consisting of protocatechuic acid esters and catecholamines.

6. The electrodepositable coating material according to claim 5, wherein the one or more compounds of formula (I) are selected from the group consisting of propyl gallate, 3,4-dihydroxybenzoic acid ethyl ester, dopamine and its salt and isoproterenol and its salt.

7. The electrodepositable coating material according to claim 1, wherein the electrodepositable coating material further comprises at least one pigment and/or filler.

8. The electrodepositable coating material according to claim 1, wherein the one or more compounds of formula (I) are contained in the electrodepositable coating material in an amount from 200 to 4000 ppm, based on a total weight of the electrodepositable coating material.

9. A method of coating a metallic substrate comprising the steps of
a. dipping a metallic substrate into an electrodeposition bath containing the electrodepositable coating material according to claim 1;
b. switching the substrate as a cathode;
c. depositing the electrodepositable coating material onto the substrate to form a coating layer; and
d. drying and curing the thus formed coating layer.

10. The method of claim 9, wherein the metallic substrate is selected from the group consisting of steel, aluminum and the alloys thereof.

11. The method of claim 9, wherein the metallic substrate is a multi-metal substrate comprising surface areas of different metal compositions.

12. The method of claim 9, wherein the metallic substrate is aluminum, an aluminum alloy, contains aluminum parts and/or contains aluminum alloy parts.

13. The method of claim 9, wherein the metallic substrate is not pre-coated.

14. A method of using one or more compounds represented by formula (I) 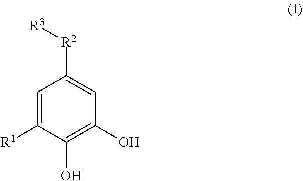
wherein
R¹ is H or OH;
R² is a divalent radical selected from the group consisting of *C(O)—O, (HO)*CH—CH₂ or *CH₂—CH₂, with * denoting the carbon atom which is bound to the benzene ring; and
R³ is a monovalent radical selected from the group consisting of NH₂, (H₃N⁺)X⁻; NHR⁴, (⁺NH₂R⁴)X⁻, or R⁴, wherein X is the anion of an organic or inorganic acid and R⁴ is a linear or branched alkyl group having 1 to 6 carbon atoms as anticorrosion agents in electrodeposition coating materials.

15. A coated metallic substrate obtained in the method according to claim 9.

16. The method of claim 9, wherein the metallic substrate is selected from the group consisting of cold-rolled steel, electrogalvanized steel, hot-dip galvanized steel, aluminum and the alloys thereof.
